(19) United States
(12) Patent Application Publication
(10) Pub. No.: US 2017/0083013 A1
(43) Pub. Date: Mar. 23, 2017

(54) CONVERSION OF A PROCEDURAL PROCESS MODEL TO A HYBRID PROCESS MODEL

(71) Applicant: International Business Machines Corporation, Armonk, NY (US)

(72) Inventors: Bing Li, Beijing (CN); Xiang Li, Beijing (CN); Xiao Jian Lian, Beijing (CN); Dan Liu, Beijing (CN); Haifeng Liu, Beijing (CN); Jing Mei, Beijing (CN); Guo Tong Xie, Beijing (CN); Yi Qin Yu, Beijing (CN); Jing Zhang, Beijing (CN)

(21) Appl. No.: 14/862,620

(22) Filed: Sep. 23, 2015

(51) Int. Cl. G05B 19/418

(52) U.S. Cl. CPC G05B 19/41885; G05B 2219/23292

(57) ABSTRACT

Disclosed are a computer-implemented method for converting a procedural process model for a process to a hybrid process model, a system and a computer program product. In this method, a plurality of steps of the process which are included in the procedural process model may be clustered selectively according to historical execution information of the plurality of steps, to generate a plurality of candidate cluster set. One candidate cluster set satisfying a first condition may be selected from the plurality of candidate cluster sets. Then, the procedural process model may be converted into the hybrid process model according to the selected candidate cluster set.

### BACKGROUND

The present disclosure relates to automation of a process, and more specifically, to converting or migrating a procedural process model for a process to a hybrid process model.

Automation of processes has been a popular strategy recently. Process models have been developed to gain insights in the processes before they are automated. The process models mainly include procedural process models and declarative process models. The procedural process models excel in modeling structured parts of the processes, but have difficulty in modeling flexible parts of the processes. The declarative process models may model the flexible parts of the processes easily, but it is not convenient for them to model the structured parts of the processes.

In view of the problems of the procedural process models and the declarative process models, hybrid process models have been proposed, which may be regarded as a mixture of the procedural process models and the declarative process models. The hybrid process models may model both the structured parts and the flexible parts of the processes conveniently.

Historically, most of the processes are modeled by the procedural process models. Therefore, there is a demand to convert or migrate the procedural process models which have been developed for the processes to the hybrid process models to better model these processes.

### SUMMARY

According to an embodiment of the present disclosure, there is provided a computer-implemented method for converting a procedural process model for a process to a hybrid process model. In this method, a plurality of steps of the process which are included in the procedural process model may be clustered selectively according to historical execution information of the plurality of steps, to generate a plurality of candidate cluster set. One candidate cluster set satisfying a first condition may be selected from the plurality of candidate cluster sets. Then the procedural process model may be converted into the hybrid process model according to the selected candidate cluster set.

According to another embodiment of the present disclosure, there is provided a system comprising one or more processors, a memory coupled to at least one of the processors, and a set of computer program instructions stored in the memory. When executed by at least one of the processors, the set of computer program instructions perform following actions. A plurality of steps of the process which are included in the procedural process model may be clustered selectively according to historical execution information of the plurality of steps, to generate a plurality of candidate cluster set. One candidate cluster set satisfying a first condition may be selected from the plurality of candidate cluster sets. Then the procedural process model may be converted into the hybrid process model according to the selected candidate cluster set.

According to a yet another embodiment of the present disclosure, there is provided computer program product for allocating data to a plurality of nodes. The computer program product comprises a computer readable storage medium having thereon first program instructions, second program instructions and third program instructions. The first program instructions are executable by a processor to cause the processor to selectively cluster a plurality of steps of the process which are included in the procedural process model, according to historical execution information of the plurality of steps, to generate a plurality of candidate cluster set. The second program instructions are executable by the processor to cause the processor to select one candidate cluster set satisfying a first condition from the plurality of candidate cluster sets. The third program instructions are executable by the processor to cause the processor to convert the procedural process model into the hybrid process model according to the selected candidate cluster set.

It is to be understood that the Summary is not intended to identify key or essential features of embodiments of the present invention, nor is it intended to be used to limit the scope of the present invention. Other features of the present invention will become comprehensible through the description below.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 shows an exemplary computer system which is applicable to implement the embodiments of the present invention;

FIG. 2 shows an exemplary procedural process model for a process;

FIG. 3 shows an example hybrid process model for a process;

FIG. 4 shows a flow chart of a method for converting a procedural process model for a process to a hybrid process model according to an embodiment of the present disclosure; and

FIG. 5 shows a block diagram of a device for converting a procedural process model for a process to a hybrid process model according to an embodiment of the present disclosure.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein.

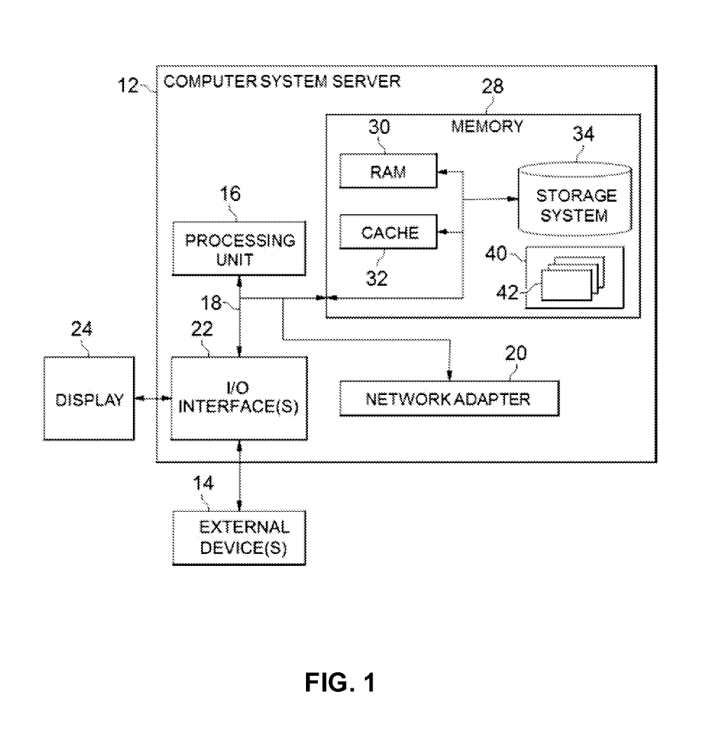

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

With reference now to the accompanying drawings, a computer-implemented method and device for converting a procedural process model for a process into a hybrid process model according to embodiments of the present disclosure will be described in detail.

The process may be a business process, an industry control process, a product manufacturing process, or some other type of process. The business process will sometimes be used hereinafter as an example of the process to describe the embodiments of the present disclosure, however it is to be appreciated that the embodiments are applicable for the other processes. Additionally, the process includes a plurality of steps. For example, a process of selling insurance may include steps of checking quotes, risk analysis, and so on. Each step is executed by and thus associated with a role, and when executed, some step(s) may generate one or more data items.

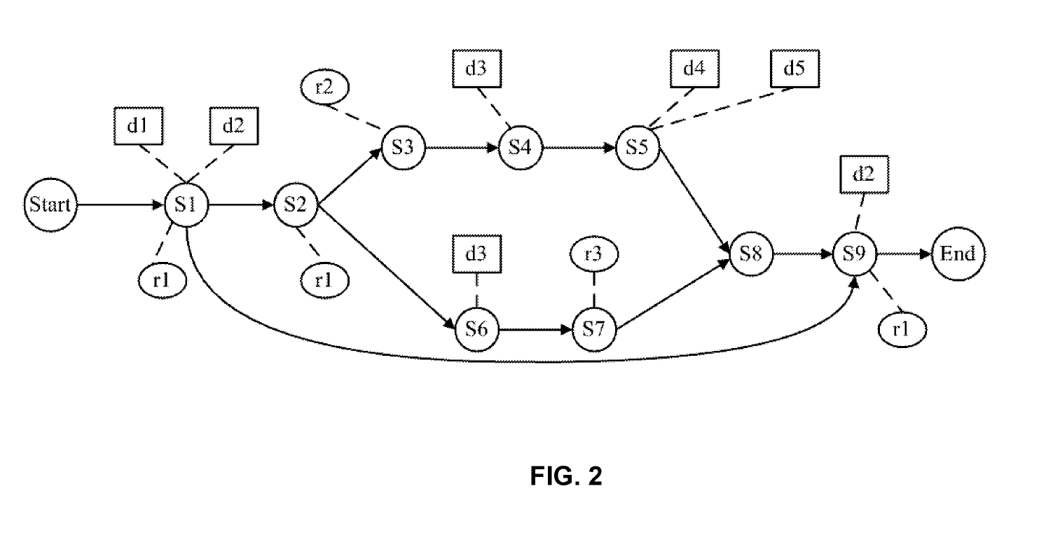

To describe the process, a procedural process model may be established. The procedural process model for the process may include the plurality of steps of the process, and uses a connection between two steps to indicate an execution order between the two steps. Specifically, the connection between the two steps in the procedural process model indicates that after one of the two steps is executed, the other one of the two steps is executed directly. Therefore, the connections between the steps included in the procedural process model define strictly the execution orders of the steps, and thus are strict connections. Additionally, each step included in the procedural process model is associated with a role performing this step, and some steps are associated with data items generated when the steps are executed. FIG. 2 shows an exemplary procedural process model for a process. This exemplary procedural process model includes nine steps as its nodes, each of which is connected to one or more steps via one or more connections shown as arrows. In this exemplary model, step S1 is executed by a role r1 and outputs data items d1 and d2. Step S2 is executed by the role r1 and does not output a data item, and step S3 is executed by a role r2 and does not output a data item. It is to be appreciated that each step has a role performing this step, but roles performing some steps shown in FIG. 2 are not shown for simplicity.

The procedural process model uses the strict connections to define the execution orders of the respective steps of the process as described above, but the strict connections may not be consistent with actual executions of the process. Specifically, when the process is executed actually, some steps may not be executed, or some steps may not be executed in the order defined by the connections included in the procedural process model. For example, although the procedural process models shown in FIG. 2 includes steps S3 and S4 connected via a (strict) connection, step S4 may not be executed directly after execution of step S3 or may not be executed at all, when the process is executed actually. Additionally, some steps in the procedural process model are correlated with each other closely and thus it is reasonable to connect them via strict connections, whereas some steps are not correlated with each other and thus it is not reasonable to define their execution orders strictly. Therefore, the procedural process model may not describe the process optimally.

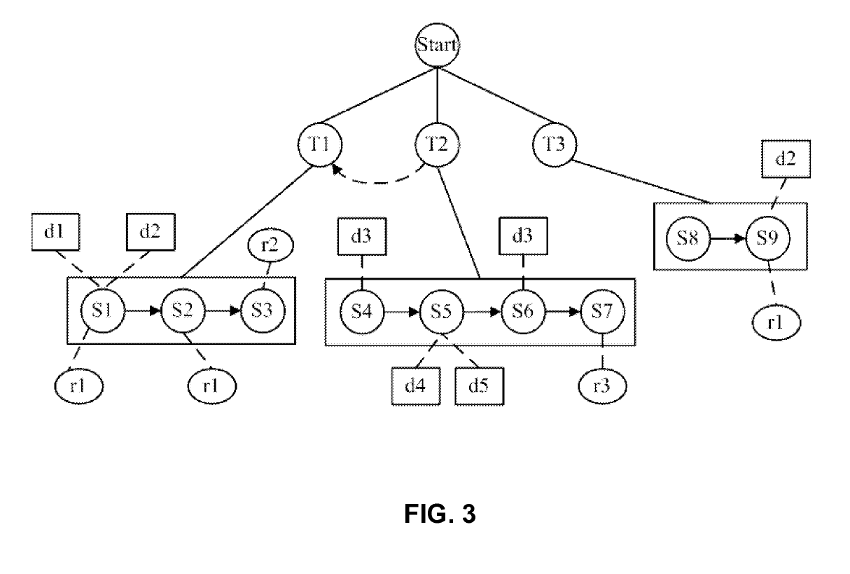

To describe the process better, the procedural process model may be converted into a hybrid process model. The hybrid process model may include one or more tasks and constraints for the tasks which define constraints on executions of the tasks. The constraints for the tasks may be shown as connections between the tasks. In this model, a connection between two tasks indicates a loose temporal relationship between the two tasks, which requires that one step is executed after another step, instead of requiring that one step is executed directly after another step, and thus is looser than the connection in the procedural process model. Therefore, the tasks correspond to a flexible part of the process. Additionally, each task may include one or more steps connected via one or more (strict) connections, therefore the steps in each task correspond to a structured part of the process. FIG. 3 shows an exemplary hybrid process model. The hybrid process model shown in FIG. 3 include three tasks, i.e. tasks T1-T3, where task T1 includes steps S1, S2 and S3, task T2 includes steps S4, S5, S6 and S7, and Task 3 includes steps S8 and S9.

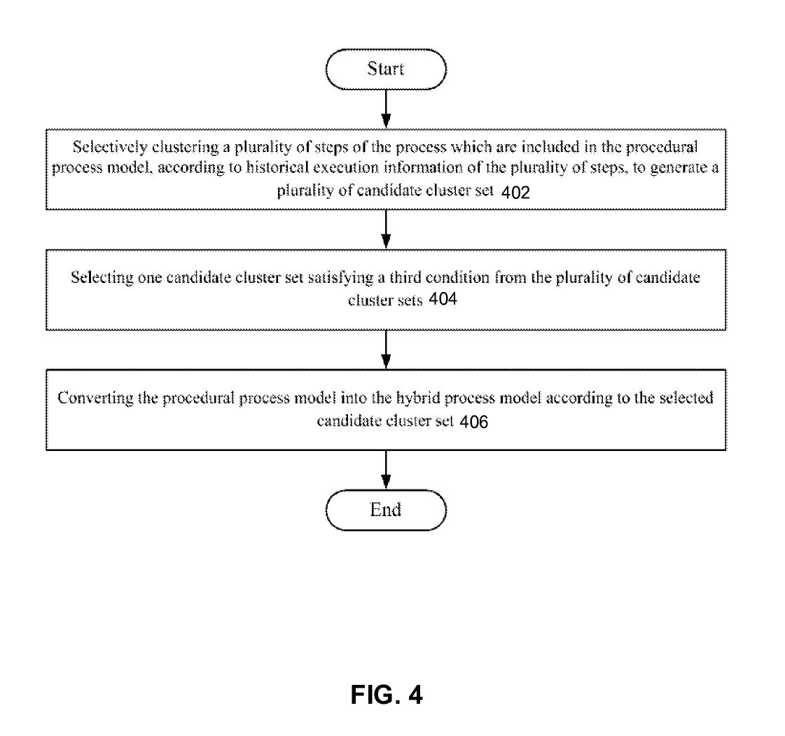

Hereinafter, the method for converting a procedural process model for a process into a hybrid process model will be described with reference to FIG. 4.

As shown in FIG. 4, in step 402, a plurality of steps of the process which are included in the procedural process model may be clustered selectively according to historical execution information of the plurality of steps, to generate a plurality of candidate cluster sets.

Specifically, the process may have been executed for many times before the conversion. As mentioned above, sometimes not all steps included in the procedural process model for the process are performed during actual executions of the process, and/or when some steps are executed, the orders in which the steps are executed may be different from the orders defined by the connections between the steps in the model. Such execution information for the process may reflect whether the related steps are necessary to be executed or necessary to be executed in the orders defined by the connections included in the procedural process model, and thus may be used to evaluate whether the respective are closely correlated. In the embodiment, the execution information regarding each historical execution of the process may be recorded in a history log. For example, each time when the process is executed, a corresponding log (i.e. history log) is generated to record details regarding this execution of the process, including, for example, executed steps and orders in which the steps are executed, data items outputted by these steps, roles executing these steps, and so on. In this way, when the process has been executed for many times, corresponding history logs may be obtained.

With the history logs associated with the process, the history execution information of the plurality of steps of the process, which are included in the procedural process model, may be determined. In the embodiment, the historical execution information of the plurality of steps including at least one of ratios of history logs in which connections between the plurality of steps occur to the plurality of history logs, ratios of history logs in which common data items for the respective steps occur to the plurality of history logs, and ratios of history logs in which common roles for the respective steps occur to the plurality of history logs.

Specifically, all the history logs may be matched with the procedural process model respectively, so as to determine, for any two steps connected via a connection in the procedural process model, how many history logs the connection between the two steps occurs in, i.e. the number of history logs in which the connection between the two steps occurs, how many history logs a common data item for the two steps occurs in, i.e. the number of history logs in which the common data item for the two steps occurs, and how many history logs a common role for the two steps occurs in, i.e. the number of history logs in which the common role for the two steps occurs. Accordingly, a ratio of the history logs in which the connection between the two steps occurs to the plurality of history logs, a ratio of the history logs in which the common data item for the two steps occurs to the plurality of history logs, and a ratio of the history log in which the common role for the two steps occurs to the plurality of history logs may be calculated. In this way, for all of the plurality of steps, the history execution information of the plurality of steps including the ratios of history logs in which connections between the plurality of steps occur to the plurality of history logs, the ratios of history logs in which common data items for the respective steps occur to the plurality of history logs, and the ratios of history logs in which common roles for the respective steps occur to the plurality of history logs may be determined. It is to be appreciated that, although the three ratios are included in the history execution information of the plurality of steps as described above, this is not limitative, and in other embodiments, the history execution information may include one or two of the three ratios.

Then, the plurality of steps of the process which are included in the procedural process model may be clustered selectively according to the history execution information of the plurality of steps, to generate the plurality of candidate cluster sets. Specifically, the clustering operation may be performed for several times, and each time the clustering operation is performed, a new candidate cluster set may be generated.

Initially, each step included in the procedural process model may be regarded as a cluster. Correlation degrees between the plurality of clusters which the plurality of steps act as respectively may be determined according to the history execution information of the steps. In the embodiment, only the correlation degree between any two clusters which are directly connected to each other via a connection may be determined. In other embodiments, it is also possible to determine the correlation degree between any two clusters which are not connected directly to each other via a connection, besides the correlation degree between any two clusters which are directly connected to each other via a connection.

The correlation degree between two clusters may be determined in various manners according to historical execution information of the steps included in the two clusters. In an implementation, as described above, the historical execution information of the steps included in the two clusters may include the ratios of history logs in which connections between the plurality of steps occur to the plurality of history logs, the ratios of history logs in which common data items for the respective steps occur to the plurality of history logs, and the ratios of history logs in which common roles for the respective steps occur to the plurality of history logs. If all or many of the ratios of occurrence of the connections between steps in one cluster and steps in another cluster in the history logs are large, which means that the steps in one cluster were often executed directly after the steps in another cluster, then the correlation degree between the two clusters may be large. Therefore, the correlation degree between two clusters may be determined such that it increases when the ratios of history logs in which connections between the plurality of steps occur to the plurality of history logs increase. Additionally, if all or many of the ratios of history logs in which common data items for the respective steps occur to the plurality of history logs are large, which means that the steps in one cluster and the steps in another cluster often generate the common data items, then the correlation degree between the two clusters may be large. Therefore, the correlation degree between two clusters may be determined such that it increases when the ratios of history logs in which common data items for the respective steps occur to the plurality of history logs increase. Moreover, if all or many of the ratios of history logs in which common roles for the respective steps occur to the plurality of history logs are large, which means that the steps in one cluster and the steps in another cluster are often executed by the same roles, then the correlation degree between the two clusters may be large. Therefore, the correlation degree between two clusters may be determined such that it increases when the ratios of history logs in which common roles for the respective steps occur to the plurality of history logs increase. It is to be appreciated that the historical execution information of the steps included in the two clusters are not limited to the rations, and may be any other suitable information derived from the logs. For example, in other embodiments, the historical execution information of the steps included in the two clusters may include the number of connections between the plurality of steps occurring in the plurality of history logs, the number of common data items for the respective steps occurring in the plurality of history logs, and the number of common roles for the respective steps occurring in the plurality of history logs.

Based on the above principle, the correlation degree between any two clusters may be determined mathematically. As an example, assume that there are m clusters. The correlation degree (CD_{i,j}) between cluster i (1<<i<<m) and cluster (1<<j<<m, i≈j) may be calculated by using a following equation:

$$\begin{matrix}{CD}_{i , j} = {DOC}_{i , j} \times ( {DIO}_{i , j} + {RO}_{i , j} ) / 2 \\ where & ( 1 ) \\ {DOC}_{i , j} = \frac{\sum {C}_{i , j}}{{pC}_{i , j}} & ( 2 ) \\ {DIO}_{i , j} = \frac{\sum {D}_{i , j}}{AD} & ( 3 ) \\ {RO}_{i , j} = \frac{\sum {R}_{i , j}}{AR} , & ( 4 )\end{matrix}$$

where G_{i,j} is a ratio of history logs in which a connection between a step in cluster i and a step in cluster j occurs to the plurality of history logs, thus ΣC_{i,j} is a sum of the ratios of history logs in which connections between all steps in cluster i and all steps in cluster j to the plurality of history logs, and pC_{i,j} is the number of possible connections between cluster i and cluster j; D_{i,j} is a ratio of history logs in which a common data item for a step in cluster i and a step in cluster j occur to the plurality of history logs, thus ΣD_{i,j} is a sum of the ratios of history logs in which all common data items between cluster i and cluster j occur to the plurality of history logs, and AD is the number of all data items generated in the process; R_{i,j} is a ratio of history logs in which a common role for a step in cluster i and a step in cluster j occurs in the plurality of history logs, thus ΣR_{i,j} is a sum of the ratios of history logs in which all common roles between cluster i and cluster j, and AR is the number of all roles involved in the process. It is to be appreciated that the above equations are only exemplary, and many other equations may be used to calculate the correlation degree between two clusters, as long as the equations follow the above principle. For example, the following equations may be used to calculate the correlation degree.

CD_{i,j}=DOC_{i,j}×(DIO_{i,j}+RO_{i,j})/4 (5)

CD_{i,j}=DOC_{i,j}×DIO_{i,j}×RO_{i,j} (6)

Additionally, in other embodiments, one or two of DoC_{i,j}, DIO_{i,j} and RO_{i,j} may be omitted from the above equations when the correlation degree is calculated.

Then, clusters whose correlation degree satisfies a first clustering condition may be clustered, so as to generate a first candidate cluster set. The first clustering condition may be set according to actual needs. For example, the first clustering condition may be set as being the largest correlation degree. In this case, two clusters having the largest correlation degree in the plurality of clusters may be clustered into a new cluster. In other embodiment, the first condition may be set as being first two largest correlation degrees, in which case two clusters having the highest correlation degree may be clustered into a new cluster, and two clusters having the second highest correlation degree may also be clustered into another new cluster.

Subsequently, the clustering operation may be performed again on the clusters in the first candidate cluster set. Specifically, correlation degrees between the respective clusters in the first candidate cluster set may be calculated, then clusters whose correlation degree satisfies a second clustering condition may be clustered to generate a second candidate cluster set. Accordingly, the second candidate cluster set include one or more new clusters generated by clustering the clusters in the first candidate cluster set whose correlation degree satisfies the second clustering condition and other clusters in the first candidate cluster set which are not clustered. The second clustering condition may be set according to actual needs, and may be the same as or different from the first clustering condition. For example, the second clustering condition may be set to be having a highest correlation degree, in which case two clusters having the highest correlation degree in the plurality of clusters of the first candidate cluster set may be clustered into a new cluster, so as to generate the second candidate cluster set. Alternatively, the second condition may be set as being first two largest correlation degrees, in which case two clusters having the highest correlation degree may be clustered into a new cluster, and two clusters having the second highest correlation degree may also be clustered into another new cluster. The calculation of the correlation degrees and the operation of clustering the clusters satisfying the second clustering condition may be performed in the same way as that described above, and a detailed description thereof is omitted here.

Similarly, the clustering operation may be performed again on the clusters in the second candidate cluster set, so as to generate a third candidate cluster set. Similarly, the third candidate cluster set include one or more new clusters generated by clustering clusters in the second candidate cluster set whose correlation degree satisfies a corresponding clustering condition and other clusters in the second candidate cluster set which are not clustered. Such clustering operation may be repeated on each candidate cluster set which is newly generated to further generate a new candidate cluster set, until all step of the process which are included in the procedural process model have been gathered in one cluster. In this way, a plurality of candidate cluster sets may be obtained.

Continuing with FIG. 4, in step 404, one candidate cluster set which satisfies a third condition may be selected from the plurality of candidate cluster sets.

The third condition may be set according to actual needs. For example, a clustering quality may be determined for each candidate cluster set, and may be used to evaluate clustering reasonability of each candidate cluster set. Briefly, if steps included in each cluster of a certain candidate cluster set are correlated with each other closely, and steps included in different clusters of the candidate cluster set are less correlated with each other, the clustering of the candidate cluster set may be reasonable, thus the clustering quality of the candidate cluster set may be good. Based on this recognition, one candidate cluster set may be selected from the plurality of candidate cluster sets based on the clustering quality, as the candidate cluster set which satisfies the third condition. For example, the third condition may be set as having a best clustering quality, so that the candidate cluster set having the best clustering quality may be selected from the plurality of candidate cluster sets.

The clustering quality of each candidate cluster set may be calculated in various ways according to correlation degrees between respective clusters in the candidate cluster set and correlation degrees between steps included in each cluster in the candidate cluster set. As described above, the clustering quality of the candidate cluster set may increase when the correlation degrees between the respective clusters in the candidate cluster set decease, and/or may increase when the correlation degrees between steps included in each cluster in the candidate cluster set increase.

As an example, assume that there are M (M>1) clusters in a candidate cluster set, then the clustering quality (CQ) of the candidate cluster set may be calculated by using the following equation:

CQ=ChD/CpD (7)

where ChD may represent the correlation degrees between the steps included in each cluster in the candidate cluster set, and CpD may represent the correlation degrees between the respective clusters in the candidate cluster set. Specifically, ChD may be calculated as follows.

$$ChD = \frac{RcH \times IcH \times UcH}{M} \qquad ( 8 )$$

In equation (8),

$$RcH = {\sum }_{i = 1}^{M} ( \frac{{C}_{i}}{pC} ) \qquad ( 9 )$$

where Cᵢ is a sum of ratios of history logs in which connections in cluster i occur to the plurality of history logs, pCᵢ is the number of possible connections in cluster i, i.e. the number of connections when all steps in cluster i are connected with each other. A larger RcH means more connections between steps are gathered within each cluster instead of being crossing the clusters, and thus may correspond to a larger correlation degree between the steps in each cluster.

Additionally,

$$IcH = {\sum }_{i = 1}^{M} ( \frac{{mDS}_{i}}{{D}_{i}} ) \qquad ( 10 )$$

where mDSᵢ is a minimum one of ratios of history logs in which data items appearing in at least two steps (i.e. common data items) in cluster i occur to the plurality of history logs, and Dᵢ is the number of data items in cluster i. A larger IcH means that more common data items appear in the same cluster, and thus the steps in each cluster are correlated with each other closely, which leads to a larger correlation degree between the steps in each cluster.

Additionally,

$$UcH = {\sum }_{i = 1}^{M} ( \frac{R - {R}_{i}}{R - 1} ) \qquad ( 11 )$$

where R is the number of roles appearing in the process, Ri is a sum of ratios of history logs in which roles in cluster i occur to the plurality of history logs. A larger UcH means that less roles are concentrated in one cluster, and thus may correspond to a larger correlation degree between the steps in the cluster.

Additionally, CpD may be calculated as follows:

CpD=RCp×ICp×UCp (12).

In equation (12),

$$RCp = ( {\sum }_{i , j > 0 ; i \neq j ; i , j ∈ M} ( \frac{{C}_{i , j}}{{pC}_{i , j}} ) ) / {C}_{M}^{2} \qquad ( 13 )$$

where C_{i,j} is a ratio of history logs in which a connection between a step in cluster i and a step in cluster j occurs to the plurality of history logs, pC_{i,j} is the number of possible connections between cluster i and cluster j, and Cₘ² is a number of all possible combinations obtained by selecting 2 clusters from the M clusters. A larger RCp means there are many connections between different clusters, and thus may correspond to a larger correlation degree between the different clusters.

Additionally,

$$ICp = {\sum }_{j = 1}^{M} ( {\sum }_{i = 1}^{M} {mDC}_{i , j} / D ) \qquad ( 14 )$$

where mDC_{i,j} is a minimum one of ratios of history logs in which data items appearing in at least cluster i and cluster j (i.e. common data items for cluster i and cluster j) occur to the plurality of history logs, and D is the number of data items in the process. A larger ICp means that there are many common data items between different clusters, and thus may correspond to a larger correlation degree between the different clusters.

Additionally,

$$UCp = ( {\sum }_{i , j > 0 ; i \neq j ; i , j ∈ M} ( \frac{C {1}_{i , j}}{C {2}_{i , j}} ) ) / {C}_{M}^{2} \qquad ( 15 )$$

where C1_{i,j} is a ratio of history logs in which a connection between a step in cluster i and a step in cluster j having a same role occurs to the plurality of history logs, and C2_{i,j} is the number of connections between cluster i and cluster j. A larger UCp means that there are many common roles between different clusters, and thus may correspond to a larger correlation degree between the different clusters.

With the above equation, the clustering quality of each candidate cluster set may be calculated. Then, one candidate cluster set may be selected based on the clustering qualities from the plurality of candidate cluster sets, as the candidate cluster set satisfying the first condition. For example, the candidate cluster set with the best clustering quality may be selected, as the candidate cluster set satisfying the third condition, from the plurality of candidate cluster sets. It is to be appreciated that the above equation is only exemplary, and many other equations may be used to calculate the clustering quality of each candidate cluster set. For example, although many parameters are used in the above equations, one or more of the parameters may be omitted.

Continuing with FIG. 4, in step 406, the procedural process model may be converted into the hybrid process model according to the selected candidate cluster set. Specifically, the procedural process model may be converted into the hybrid process model by converting the respective clusters in the selected candidate cluster set into corresponding tasks of the hybrid process model and converting connections between the clusters into constraints for corresponding tasks. Take FIG. 2 as an example. Assume that in the selected candidate cluster set, steps S1-S3 are included in a cluster, steps S4-S7 are included in a cluster, and steps S8-S9 are included in a cluster, then the three clusters may be converted into three task T1-T3 of the hybrid process model, where task T1 includes steps S1-S3, task T2 includes steps S4-S7, and task T3 includes steps S8-S9. Additionally, the connections between every two clusters may be converted into constraints for the corresponding tasks. The tasks and the steps may be placed on different levels of the hybrid process model. Then, the hybrid process model shown in FIG. 3 may be obtained.

With the above method according to the embodiment of the present disclosure, the procedural process model may be converted into the hybrid process conveniently and quickly.

The respective embodiments for implementing the method of the present disclosure have been described with reference to the accompanying drawings hereinbefore. Those skilled in the art may understand that the above method may be implemented in software, in hardware, or in a combination thereof. Further, those skilled in the art may understand that by implementing the respective steps in the above method in software, in hardware, or in a combination thereof, a device for converting a procedural process model for a process into a hybrid process model based on the same inventive concept may be provided. Even if a hardware configuration of the device is the same as that of a general-purpose processing device, the device will exhibit characteristics different from the general-purpose processing device due to a function of software contained therein, so as to form the device according to the embodiment of the present disclosure. The device of the present disclosure comprises a plurality of units or modules, which are configured to execute corresponding steps. Those skilled in the art may understand how to write a program to implement actions of the units or modules by reading the present specification.

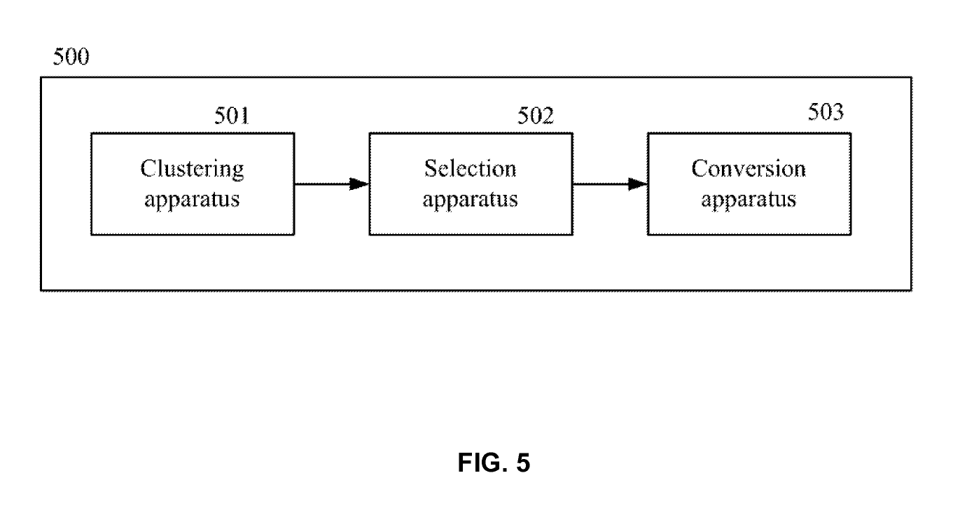

With reference now to FIG. 5, the device for allocating data to a plurality of servers will be described. Since the device and the method are based on the same inventive concept, the same or corresponding implementation details in the above method are also applicable to the device corresponding to the above method, and these implementation details will not be described below because they have been described in the above in detail and completely.

As shown in FIG. 5, the device 500 for converting a procedural process model for a process into a hybrid process model according to the embodiment of the present disclosure may include a clustering apparatus 501, a selection apparatus 502, and a conversion apparatus 503.

The clustering apparatus 501 may cluster selectively a plurality of steps of the process which are included in the procedural process model according to historical execution information of the plurality of steps, to generate a plurality of candidate cluster set.

The clustering apparatus 501 may determine the history execution information of the plurality of steps of the process included in the procedural process model according to the history logs associated with the process. In the embodiment, the historical execution information of the plurality of steps may include at least one of ratios of history logs in which connections between the plurality of steps occur to the plurality of history logs, ratios of history logs in which common data items for the respective steps occur to the plurality of history logs, and ratios of history logs in which common roles for the respective steps occur to the plurality of history logs. In other embodiments, the historical execution information of the plurality of steps may include other information, such as the respective numbers described above with reference to FIG. 4

Specifically, the clustering apparatus 501 may match all the history logs with the procedural process model respectively, so as to determine, for any two steps connected via a connection in the procedural process model, how many history logs the connection between the two steps occurs in, i.e. the number of history logs in which the connection between the two steps occurs, how many history logs a common data item for the two steps occurs in, i.e. the number of history logs in which the common data item for the two steps occurs, and how many history logs a common role for the two steps occurs in, i.e. the number of history logs in which the common role for the two steps occurs. Accordingly, a ratio of the history logs in which the connection between the two steps occurs to the plurality of history logs, a ratio of the history logs in which the common data item for the two steps occurs to the plurality of history logs, and a ratio of the history log in which the common role for the two steps occurs to the plurality of history logs may be calculated by the clustering apparatus 501.

Then, the clustering apparatus 501 may cluster the plurality of steps of the process which are included in the procedural process model selectively according to the history execution information of the plurality of steps, to generate the plurality of candidate cluster sets.

Specifically, the clustering apparatus 501 may perform the clustering operation for several times. Initially, each step included in the procedural process model may be regarded as a cluster. The clustering apparatus 501 may determine correlation degrees between the plurality of clusters which the plurality of steps act as respectively in the manner described above according to the history execution information of the steps. In the embodiment, only the correlation degree between any two clusters which are directly connected to each other via a connection may be determined. In other embodiments, it is also possible to determine the correlation degree between any two clusters which are connected directly to each other via a connection, besides the correlation degree between any two clusters which are directly connected to each other via a connection. Then, the clustering apparatus 501 may cluster clusters whose correlation degree satisfies a first clustering condition, so as to generate a first candidate cluster set. The first clustering condition may be set according to actual needs. For example, the first clustering condition may be set as being the largest correlation degree.

Subsequently, the clustering apparatus 501 may perform the clustering operation again on the clusters in the first candidate cluster set. Specifically, the clustering apparatus 501 may determine correlation degrees between the respective clusters in the first candidate cluster set, then may cluster clusters whose correlation degree satisfies a second clustering condition to generate a second candidate cluster set. The second clustering condition may be set according to actual needs, and may be the same as or different from the first clustering condition. For example, the second clustering condition may be set to be having a highest correlation degree, in which case two clusters having the highest correlation degree in the plurality of clusters of the first candidate cluster set may be clustered into a new cluster, so as to generate a second candidate cluster set.

Similarly, the clustering apparatus 501 may perform the clustering operation again on the clusters in the second candidate cluster set, so as to generate a third candidate cluster set. Such clustering operation may be repeated on each candidate cluster set which is newly generated to further generate a new candidate cluster set, until all step of the process which are included in the procedural process model have been gathered in one cluster. In this way, a plurality of candidate cluster sets may be obtained by the clustering apparatus 501.

The selection apparatus 502 may select one candidate cluster set which satisfies a third condition from the plurality of candidate cluster sets.

The third condition may be set according to actual needs. For example, the selection apparatus 502 may determine a clustering quality for each candidate cluster set, which may be used to evaluate clustering reasonability of each candidate cluster set. Briefly, if steps included in each cluster of a certain candidate cluster set are correlated with each other closely, and steps included in different clusters of the candidate cluster set are less correlated with each other, the clustering of the candidate cluster set may be reasonable, thus the clustering quality of the candidate cluster set may be good. Based on this recognition, the selection apparatus 502 may select one candidate cluster set from the plurality of candidate cluster sets based on the clustering quality, as the candidate cluster set which satisfies the third condition. For example, the third condition may be set as having a best clustering quality, so that the candidate cluster set having the best clustering quality may be selected by the selection apparatus 502 from the plurality of candidate cluster sets.

The selection apparatus 502 may calculate the clustering quality of each candidate cluster set in the manner described above according to correlation degrees between respective clusters in the candidate cluster set and correlation degrees between steps included in each cluster in the candidate cluster set. As described above, the clustering quality of the candidate cluster set may increase when the correlation degrees between the respective clusters in the candidate cluster set decease, and/or may increase when the correlation degrees between steps included in each cluster in the candidate cluster set increase.

The conversion apparatus 503 may convert the procedural process model into the hybrid process model according to the selected candidate cluster set. Specifically, the conversion apparatus 503 may convert the procedural process model into the hybrid process model by converting the respective clusters in the selected candidate cluster set into corresponding tasks of the hybrid process model and converting connections between the clusters into constraints for corresponding tasks.

With the above device according to the embodiment of the present disclosure, the procedural process model may be converted into the hybrid process conveniently and quickly.

The respective embodiments for implementing the method of the present disclosure have been described with reference to the accompanying drawings hereinbefore. Those skilled in the art may understand that the above method may be implemented in software, in hardware, or in a combination thereof. Further, those skilled in the art may understand that by implementing the respective steps in the above method in software, in hardware, or in a combination thereof, a device for converting a procedural process model for a process into a hybrid process model based on the same inventive concept may be provided. Even if a hardware configuration of the device is the same as that of a general-purpose processing device, the device will exhibit characteristics different from the general-purpose processing device due to a function of software contained therein, so as to form the device according to the embodiment of the present disclosure. The device of the present disclosure comprises a plurality of units or modules, which are configured to execute corresponding steps. Those skilled in the art may understand how to write a program to implement actions of the units or modules by reading the present specification.

The present invention may be a system, a method, and/or a computer program product. The computer program product may include a computer readable storage medium (or media) having computer readable program instructions thereon for causing a processor to carry out aspects of the present invention. For example, a computer program product for converting a procedural process model for a process into a hybrid process model may comprise a computer readable storage medium having thereon first program instructions, second program instructions and third program instructions. The first program instructions are executable by a processor to cause the processor to selectively cluster a plurality of steps of the process which are included in the procedural process model, according to historical execution information of the plurality of steps, to generate a plurality of candidate cluster set. The second program instructions are executable by the processor to cause the processor to select one candidate cluster set satisfying a first condition from the plurality of candidate cluster sets. The third program instructions are executable by the processor to cause the processor to convert the procedural process model into the hybrid process model according to the selected candidate cluster set. In the embodiment, when the plurality of steps of the process which are included in the procedural process model are clustered selectively according to historical execution information of the plurality of steps, to generate a plurality of candidate cluster set, correlation degrees among a plurality of clusters which the plurality of steps act as respectively may be determined, and clusters whose correlation degree satisfies a second condition may be clustered to generate a first candidate cluster set including a plurality of clusters. Additionally, correlation degrees among the respective clusters in the first candidate cluster set may be determined, and clusters whose correlation degree satisfies a third condition may be further clustered to generate a second candidate cluster set including a plurality of clusters. Furthermore, when the operation of selecting one candidate cluster set satisfying a first condition from the plurality of candidate cluster sets is performed, clustering qualities of the plurality of candidate cluster sets may be calculated, and one candidate cluster set may be selected based on the clustering qualities from the plurality of candidate cluster sets.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for converting a procedural process model for a process to a hybrid process model, comprising:
selectively clustering a plurality of steps of the process which are included in the procedural process model, according to a historical execution information of the plurality of steps, to generate a plurality of candidate cluster sets;
selecting one candidate cluster set satisfying a first condition from the plurality of candidate cluster sets; and
converting the procedural process model into the hybrid process model according to the selected candidate cluster set.

2. The computer-implemented method of claim 1, further comprising:
determining the historical execution information of the plurality of steps according to a plurality of history logs associated with a historical execution of the process.

3. The computer-implemented method of claim 2, wherein the historical execution information of the plurality of steps includes at least one of ratios of history logs in which connections between the plurality of steps occur to the plurality of history logs, ratios of history logs in which common data items for the respective steps occur to the plurality of history logs, and ratios of history logs in which common roles for the respective steps occur to the plurality of history logs.

4. The computer-implemented method of claim 1, wherein the selectively clustering a plurality of steps of the process which are included in the procedural process model, according to historical execution information of the plurality of steps, to generate a plurality of candidate cluster set comprises:
determining correlation degrees between a plurality of clusters which the plurality of steps act as respectively; and
clustering clusters whose correlation degree satisfies a second condition, to generate a first candidate cluster set including a plurality of clusters.

5. The computer-implemented method of claim 4, wherein the selectively clustering a plurality of steps of the process which are included in the procedural process model, according to the historical execution information of the plurality of steps, to generate a plurality of candidate cluster set further comprises:
determining correlation degrees between the respective clusters in the first candidate cluster set; and
clustering clusters whose correlation degree satisfies a third condition, to generate a second candidate cluster set including a plurality of clusters.

6. The computer-implemented method of claim 1, wherein the selecting one candidate cluster set satisfying a first condition from the plurality of candidate cluster sets comprises:
calculating clustering qualities of the plurality of candidate cluster sets; and
selecting one candidate cluster set based on the clustering qualities, as the candidate cluster set satisfying the first condition, from the plurality of candidate cluster sets.

7. The computer-implemented method of claim 6, wherein a clustering quality of a candidate cluster set increases in response to that correlation degrees between respective clusters in the candidate cluster set decrease, or in response to that correlation degrees between steps included in each cluster in the candidate cluster set increase.

8. The computer-implemented method of claim 1, wherein the converting the procedural process model into the hybrid process model according to the selected one candidate cluster set comprises:
converting the procedural process model into the hybrid process model by converting respective clusters in the selected one candidate cluster set into corresponding tasks and converting connections between the respective clusters into constraints for corresponding tasks.

9. A system comprising:
one or more processors;
a memory coupled to at least one of the processors;
a set of computer program instructions stored in the memory, which, when executed by at least one of the processors, perform actions comprising:
selectively clustering a plurality of steps of a process which are included in a procedural process model, according to a historical execution information of the plurality of steps, to generate a plurality of candidate cluster sets;
selecting one candidate cluster set satisfying a first condition from the plurality of candidate cluster sets; and
converting the procedural process model into a hybrid process model according to the selected one candidate cluster set.

10. The system of claim 9, wherein the set of computer program instructions, when executed by the at least one of the processors, further perform actions of:
determining the historical execution information of the plurality of steps according to a plurality of history logs associated with a historical execution of the process.

11. The system of claim 10, wherein the historical execution information of the plurality of steps includes at least one of ratios of history logs in which connections between the plurality of steps occur to the plurality of history logs, ratios of history logs in which common data items for the respective steps occur to the plurality of history logs, and ratios of history logs in which common roles for the respective steps occur to the plurality of history logs.

12. The system of claim 9, wherein the selectively clustering a plurality of steps of the process which are included in the procedural process model, according to the historical execution information of the plurality of steps, to generate a plurality of candidate cluster set comprises:
determining correlation degrees between a plurality of clusters which the plurality of steps act as respectively; and
clustering clusters whose correlation degree satisfies a second condition, to generate a first candidate cluster set including a plurality of clusters.

13. The system of claim 12, wherein the selectively clustering a plurality of steps of the process which are included in the procedural process model, according to the historical execution information of the plurality of steps, to generate a plurality of candidate cluster set further comprises:
determining correlation degrees between the respective clusters in the first candidate cluster set; and
clustering clusters whose correlation degree satisfies a third condition, to generate a second candidate cluster set including a plurality of clusters.

14. The system of claim 9, wherein the selecting one candidate cluster set satisfying a first condition from the plurality of candidate cluster sets comprises:
calculating clustering qualities of the plurality of candidate cluster sets; and
selecting one candidate cluster set based on the clustering qualities, as the candidate cluster set satisfying the first condition, from the plurality of candidate cluster sets.

15. The system of claim 14, wherein a clustering quality of a candidate cluster set increases in response to that correlation degrees between respective clusters in the candidate cluster set decrease, or in response to that correlation degrees between steps included in each cluster in the candidate cluster set increase.

16. The system of claim 9, wherein the converting the procedural process model into the hybrid process model according to the selected one candidate cluster set comprises:
converting the procedural process model into the hybrid process model by converting respective clusters in the selected candidate cluster set into corresponding tasks of the hybrid process model and converting connections between the respective clusters into constraints for corresponding tasks.

17. A computer program product for converting a procedural process model for a process to a hybrid process model, comprising:
a computer readable storage medium having thereon:
first program instructions executable by a processor to cause the processor to selectively cluster a plurality of steps of a process which are included in a procedural process model, according to a historical execution information of the plurality of steps, to generate a plurality of candidate cluster sets;
second program instructions executable by the processor to cause the processor to select one candidate cluster set satisfying a first condition from the plurality of candidate cluster sets; and
third program instructions executable by the processor to cause the processor to convert the procedural process model into a hybrid process model according to the selected one candidate cluster set.

18. The computer program product of claim 17, wherein the selectively clustering a plurality of steps of the process which are included in the procedural process model, according to the historical execution information of the plurality of steps, to generate a plurality of candidate cluster set comprises:
determining correlation degrees between a plurality of clusters which the plurality of steps act as respectively; and
clustering clusters whose correlation degree satisfies a second condition, to generate a first candidate cluster set including a plurality of clusters.

19. The computer program product of claim 18, wherein the selectively clustering a plurality of steps of the process which are included in the procedural process model, according to the historical execution information of the plurality of steps, to generate a plurality of candidate cluster set further comprises:
determining correlation degrees between the respective clusters in the first candidate cluster set; and
clustering clusters whose correlation degree satisfies a third condition, to generate a second candidate cluster set including a plurality of clusters.

20. The computer program product of claim 17, wherein the selecting one candidate cluster set satisfying a first condition from the plurality of candidate cluster sets comprises:
calculating clustering qualities of the plurality of candidate cluster sets; and
selecting one candidate cluster set based on the clustering qualities, as the candidate cluster set satisfying the first condition, from the plurality of candidate cluster sets.
